(19) United States
(12) Patent Application Publication
(10) Pub. No.: US 2012/0153191 A1
(43) Pub. Date: Jun. 21, 2012

(54) Vivarium

(75) Inventors: Daniel James Greenhill Kane, Glasgow (GB); Gregor John Aikman, Glasgow (GB)

(73) Assignee: Meso Limited, Renfrew (GB)

(21) Appl. No.: 13/380,800

(22) PCT Filed: Jun. 25, 2010
(86) PCT No.: PCT/GB2010/051054

§ 371 Date: Jan. 26, 2012

(30) Foreign Application Priority Data
Jun. 25, 2009 (GB) 0911003.2

(51) Int. Cl. A01K 1/03; F21V 33/00; A01K 1/00

(52) U.S. Cl. 250/504 R; 119/416; 119/455; 362/253

(57) ABSTRACT

Vivarium (100) comprising a housing capable of providing a habitat for an animal wherein the housing comprises plastics material with anti-bacterial properties.

### FIELD OF THE INVENTION

This invention relates to an improved vivarium. More particularly, the present invention relates to an improved vivarium capable of providing an improved living environment for a range of animals.

### BACKGROUND OF THE INVENTION

Although there are many different types of vivariums on the market these prior art types of vivariums have a number of disadvantages. For example, previous vivariums are mainly made of wood such as MDF and the like which usually have ventilation ports at the back of the vivarium which provides efficient ventilation. Moreover, previous vivariums which are made of wood have, in effect, a well insulated box which is difficult to heat which may be necessary for cold blooded contained animals. Therefore, by placing a heat mat on the underside of these wooden vivariums is highly inefficient. The applied heat may also lead to peeling of the wood. The pores in the wood are also known to act as a host for bacteria which can inevitably lead to the growth of bacteria and hence result in the contained animals becoming subject to disease.

It is an object of at least one aspect of the present invention to obviate and/or mitigate at least one or more of the aforementioned problems.

It is a further object of at least one aspect of the present invention to provide an improved vivarium.

It is a yet further aspect of at least one aspect of the present invention to provide an improved vivarium capable of providing an improved living environment for a range of animals.

### SUMMARY OF THE INVENTION

According to a first aspect of the present invention there is provided a vivarium comprising:

a housing capable of providing a habitat for an animal;

wherein the housing comprises plastics material with anti-bacterial properties.

The present invention resides in the provision of providing a vivarium capable of providing an improved environment for contained animals. A range of animals may be stored in the vivarium according to the present invention such as reptiles (e.g. snakes, lizards, etc) and other animals such as rodents and spiders. The vivariums may also be used in the home, for breeding purposed and/or in a pet shop. The vivariums may also comprise vegetation for the animals.

The housing may comprise a main body comprised of and/or coated with anti-bacterial material. The body of the vivarium may be manufactured using any suitable moulding method such as, for example, rotational moulding. The anti-bacterial components may therefore be either integrated into the plastics forming the vivarium or may be in the form of a coating. As the vivarium is made from plastics material this therefore also provides a well-insulated environment for keeping contained animals warm and in a stable temperature and/or humidity environment.

The vivarium may comprise a top surface, a bottom surface, a front surface, a rear surface and two sides.

The front surface may comprise, for example, two substantially rectangular glass portions which may be capable of being slid or swung to open and close the vivarium. This may allow easy access to animals and facilitates cleaning and other general maintenance. The glass portions may be moved using any suitable mechanical means such as knobs and the like.

On the front surface of the vivarium there may be upper and lower portions within which there may be a series of vents which may allow for ventilation. In contrast to prior art vivariums where ventilation is mainly provided on the rear surface, the vents are preferably located on the front surface which provides improved ventilation.

The upper portion of the vivarium may comprise a drawer within which food and other articles required for keeping animals may be kept. Within the lower portion there may be a tray which may be used for cleaning the vivarium. Within the lower portion there may also be a housing within which a heating mat may be placed. The heating mat may be used to warm cold blooded animals such as reptiles.

On the top surface of the vivarium there may be longitudinal protruding members, for example two longitudinal protruding members, which may be used to stack one vivarium on top of another. On the bottom surface of the vivarium there may be extended indents, for example two indents, which may be used to fit over upper located protruding members of another vivarium. The vivarium of the present invention therefore has stackability. Moreover, on the sides of the vivarium of the present invention there may be longitudinal indents which again may be used to inter-engage with other vivariums to provide stackability.

The vivarium according to the present invention may also comprise an integrated light management system. The light management system may be capable of having a series of different lights such as UV lights and/or IR lights which can be used to provide a combination of heat and/or light to the inner compartment of the vivarium. The light management system may also comprise a diffuser in the upper area of the vivarium which can be used to diffuse the light. The light management system may electronically control the light and may, for example, comprise control means for controlling any one of or combination of the following: temperature; light; ventilation and moisture. The light management system may also be programmable. By providing a programmable light management system would allow a user to leave their animal safely when going on holiday provided that enough food was left for the animal. Many animals such as specific reptiles require specific dosages of UV light to survive and maintain a healthy metabolism and the light management system can therefore be programmed to provide the required light for different animals.

According to a second aspect of the present invention there is provided a method for preventing or at least reducing the formation of bacteria in a vivarium by:

providing a housing;

wherein the housing comprises plastics material with anti-bacterial properties.

The vivarium may be as described in the first aspect.

According to a third aspect of the present invention there is provided a use of a vivarium as described in the first aspect in preventing or at least reducing the formation of bacteria in the vivarium.

### BRIEF DESCRIPTION OF THE DRAWINGS

Embodiments of the present invention will now be described, by way of example only, with reference to the accompanying drawings in which:

FIG. 1 is a representation of a vivarium according to an embodiment of the present invention wherein there is vegetation in the vivarium; and

FIG. 2 is a further representation of the vivarium shown in FIG. 1 with no vegetation.

### BRIEF DESCRIPTION

Generally speaking, the present invention resides in the provision of providing a vivarium capable of providing an improved environment for contained animals.

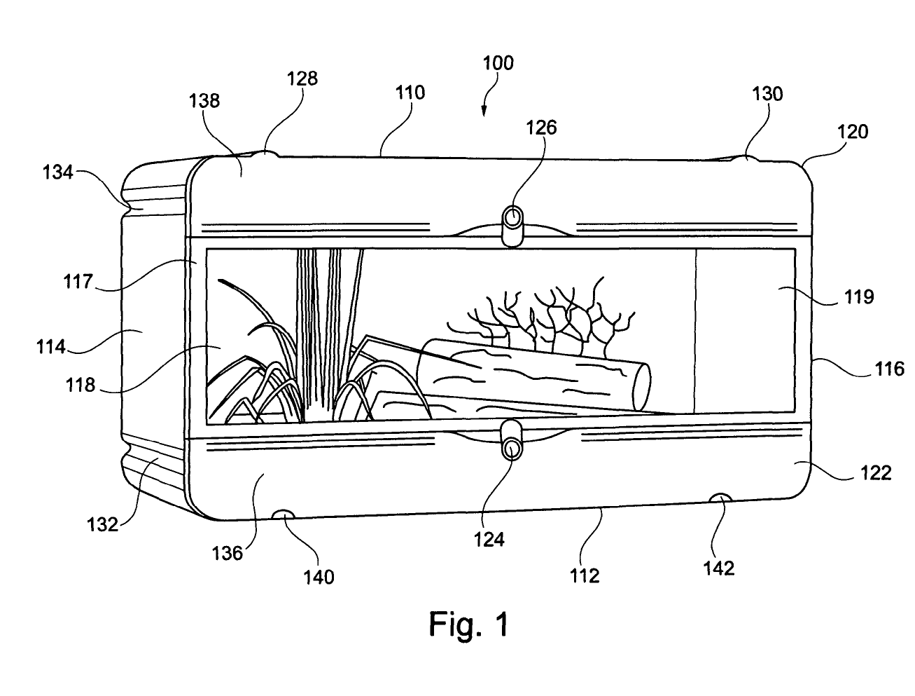

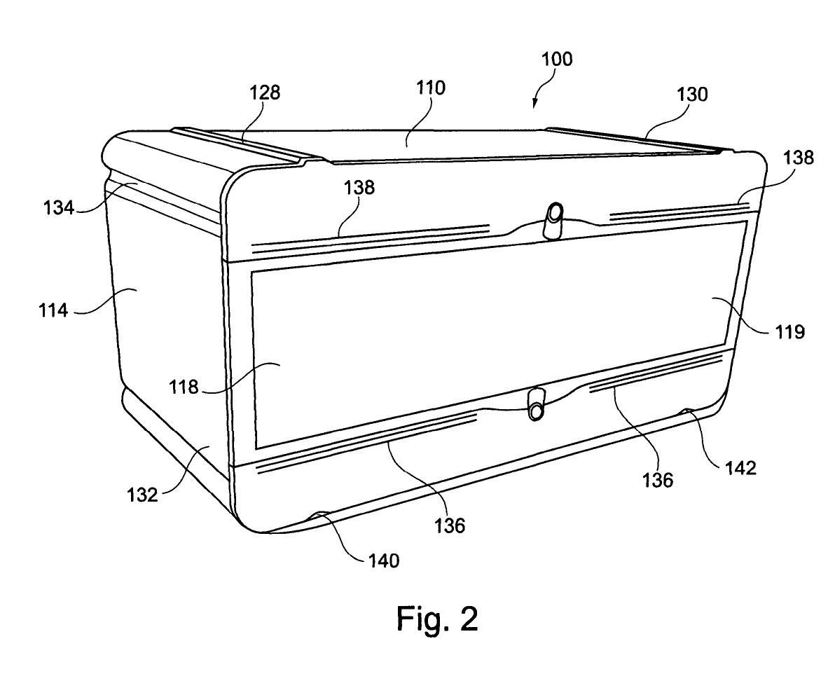

FIG. 1 and are representations of a vivarium according to the present invention, generally designated 100. In FIG. 1 the vivarium 100 has some vegetation whereas in FIG. 2 there is no vegetation. The vivarium 100 comprises a top surface 110 and a bottom surface 112. FIG. 1 also shows that the vivarium 100 comprises two sides 114, 116 along with a front surface generally designated 117 and a rear surface (not shown).

The front surface 117 comprises two substantially rectangular glass portions 118, 119 which are capable of being slid to open and close the vivarium 100. This allows easy access to animals and facilitates cleaning and other general maintenance. The glass portion 118,119 may be moved using the two knobs 124,126.

On the front surface 117 of the vivarium there are upper and lower portions 120, 122 within which there are a series of vents 136, 138 which allow ventilation of the vivarium 100. In contrast to prior art vivariums where ventilation is mainly provided on the rear surface, the vents 136, 138 are located on the front surface 117 which allows improved ventilation. The upper portion 120 may comprise a drawer within which food and other articles required for keeping animals may be kept. Within the lower portion 122 there may be a tray (not shown) which may be used for the cleaning process of the vivarium 100. Within the lower portion 122 there may also be a housing within which a heating mat may be placed. The heating mat may be used to warm cold blooded animals such as reptiles.

As shown in FIGS. 1 and 2, the top surface 110 comprises two longitudinal protruding members 128, 130 which may be used to stack one vivarium on top of another. On the bottom surface 112 of the vivarium 100, and as shown in FIGS. 1 and 2 there are two extended indents 140, 142 which may be used to fit over the protruding members 128, 130 of another vivarium. The vivarium 100 therefore has stackability. Moreover, on side 114 there are also shown two longitudinal indents 132, 134 which again may be used to inter-engage with other vivariums.

A specific feature of the vivarium 100 presently described is that the material used for manufacturing the main body is comprised of and/or coated with anti-bacterial material. The body of the vivarium may be manufactured using any suitable moulding method such as rotational moulding. The anti-bacterial components may therefore be either integrated into the plastics forming the vivarium or may be in the form of a coating. The rotational moulding process uses a heated mould which causes material within that to melt and form a liquid material at the bottom of a mould cavity. The mould is then slowly rotated (for example around two perpendicular axes) causing the melted material to flow into the mould and to stick to its walls. In order to maintain even thickness throughout the moulded part, the mould continues to rotate during the cooling phase. During this process the anti-bacterial components may be either directly integrated into the melted plastics material or may be added in a final layer on top of the hot moulded plastic. Any suitable anti-bacterial components may be used such as silver and other standard anti-bacterial agents.

As the vivarium 100 is made from plastics material this therefore also provides a well-insulated environment for keeping contained animals warm and in a stable temperature and/or humidity environment. The vivarium 100 according to the present invention also has an integrated light management system. The light management system is capable of having a series of different lights such as UV lights and/or IR lights which can be used to provide a combination of heat and/or light to the inner compartment of the vivarium 100. The light management system may also comprise a diffuser in the upper area of the vivarium 100 which can be used to diffuse the light. The light management system may electronically control the light and may, for example, comprise control means for controlling any one of or combination of the following: temperature; light; ventilation and moisture. The light management system may also be programmable. By providing a programmable light management system would allow a user to leave their animal safely when going on holiday provided that enough food was left for the animal. Many animals such as specific reptiles require specific dosages of UV light to survive and maintain a healthy metabolism and the light management system can therefore be programmed to provide the required light for different animals.

1. A vivarium comprising:
a housing capable of providing a habitat for an animal;
wherein the housing comprises plastics material with anti-bacterial properties.

2. A vivarium according to claim 1, wherein the housing comprises a main body comprised of and/or coated with anti-bacterial material.

3. A vivarium according to claim 1, wherein the vivarium is manufactured using any suitable moulding method including that of rotational moulding.

4. A vivarium according to claim 1, wherein the anti-bacterial components are either integrated into the plastics forming the vivarium or are in the form of a coating.

5. A vivarium according to claim 1, wherein the vivarium comprises a top surface, a bottom surface, a front surface, a rear surface and two sides.

6. A vivarium according to claim 5, wherein the front surface comprises glass portions capable of being slid or swung to open and close the vivarium.

7. A vivarium according to claim 1, wherein on the front surface of the vivarium there are upper and lower portions within which there are a series of vents which allow for ventilation.

8. A vivarium according to claim 1, wherein an upper portion of the vivarium comprises a drawer within which food and other articles required for keeping animals are capable of being kept.

9. A vivarium according to claim 1, wherein within the lower portion there is a tray which is capable of being used for cleaning the vivarium.

10. A vivarium according to claim 1, wherein within the lower portion there is an opening within which a heating mat may be placed.

11. A vivarium according to claim 1, wherein on the top surface of the vivarium are longitudinal protruding members which are capable of being used to stack one vivarium on top of another.

12. A vivarium according to claim 1, wherein on the bottom surface of the vivarium there are extended indents which are capable of being used to fit over upper located protruding members of another vivarium.

13. A vivarium according to claim 1, wherein on the sides of the vivarium there are longitudinal indents which are capable of being used to inter-engage with other vivariums to provide stackability.

14. A vivarium according to claim 1, wherein the vivarium comprises an integrated light management system.

15. A vivarium according to claim 14, wherein the light management system comprises a series of different lights such as UV lights and/or IR lights which are capable of being used to provide a combination of heat and/or light to the housing of the vivarium.

16. A vivarium according to claim 14, wherein the light management system comprises a diffuser.

17. A vivarium according to claim 14, wherein the light management system is capable of electronically controlling the light and comprises control means for controlling any one of or combination of the following: temperature;
light; ventilation and moisture.

18. A vivarium according to claim 14, wherein the light management system is programmable.

19. A method for preventing or at least reducing the formation of bacteria in a vivarium by:
providing a housing;
wherein the housing comprises plastics material with anti-bacterial properties.

20. A method for preventing or at least reducing the formation of bacteria in a vivarium according to claim 19 wherein the vivarium is as defined in claim 1.

21. (canceled)

22. (canceled)

23. A vivarium according to claim 15, wherein the light management system comprises a diffuser.
